(19) United States
(12) Patent Application Publication
(10) Pub. No.: US 2013/0180431 A1
(43) Pub. Date: Jul. 18, 2013

(54) ZEOLITE AND LIME COMBINATIONS FOR WARM MIX ASPHALT

(71) Applicants: Edward A. Myszak, JR., West Chester, PA (US); Flavio Ernesto Ribeiro, Plainfield, IL (US); Dallas N. Little, Bryan, TX (US)

(72) Inventors: Edward A. Myszak, JR., West Chester, PA (US); Flavio Ernesto Ribeiro, Plainfield, IL (US); Dallas N. Little, Bryan, TX (US)

(21) Appl. No.: 13/553,382

(22) Filed: Jul. 19, 2012

Related U.S. Application Data
(60) Provisional application No. 61/509,695, filed on Jul. 20, 2011.

(51) Int. Cl. C08L 95/00

(52) U.S. Cl. CPC C08L 95/00
USPC 106/283; 106/461; 106/466; 106/470; 106/284.04

(57) ABSTRACT

Embodiments are presented herein that provide a filler that is a combination of zeolite and hydrated lime. Addition of this filler to asphalt is more beneficial than addition of either zeolite or hydrated lime alone. The beneficial properties of zeolite include a controlled release of moisture that aids mixture workability and the ability of the asphalt to effectively coat the aggregate particles. The mixture of zeolite and hydrated lime is easier to handle and integrate into a process than use of either compound alone, and it offers a number of other benefits.

### BACKGROUND OF THE INVENTION

1. Field of the Invention

Embodiments of the invention relate to methods and compositions for mixtures of zeolite with lime for use in hot mix asphalt. Other embodiments related to hot mix asphalt containing lime and zeolite and methods for making hot mix asphalt containing lime and zeolite.

2. Description of the Related Art

Asphalt cement, also known as bitumen, mastic, or asphalt binder, is made up primarily of high molecular weight aliphatic hydrocarbon compounds, but also small concentrations of other materials such as sulfur, nitrogen, and polycyclic hydrocarbons (aromatic and/or naphthenic) of very low chemical reactivity. These hydrocarbons are typically a combination of asphaltenes and maltenes. Maltenes are typically present as resins and oils. Asphaltenes are more viscous than either resins or oils and play a major role in determining asphalt viscosity. Oxidation of aged asphalt causes the oils to convert to resins and the resins to convert to asphaltenes, resulting in age hardening and a higher viscosity binder. In U.S. and Polish terminology, asphalt (or asphalt cement) is the carefully refined residue from the distillation process of selected crude oils. Outside these countries, the product is often called bitumen.

Zeolites are microporous crystalline solids with well-defined structures. Generally they contain silicon, aluminum and oxygen in their framework and cations (such as Na⁺, K⁺, Ca²⁺, Mg²⁺ and others), water and/or other molecules within their pores. These positive ions are rather loosely held and can readily be exchanged for others in a contact solution. Many occur naturally as minerals, and are extensively mined in many parts of the world. Others are synthetic, and are made commercially for specific uses. An example of a mineral formula for a zeolite is: Na₂Al₂Si₃O₁₀.2H₂O, the formula for natrolite.

There are several types of synthetic zeolites that form by a process of slow crystallization of a silica-alumina gel in the presence of alkalis and organic templates. The product properties depend on reaction mixture composition, pH of the system, operating temperature, pre-reaction ‘seeding’ time, reaction time as well as the templates used. Preparation of synthetic zeolites suitable for use in embodiments of the invention is shown, for example, in U.S. Pat. No. 4,661,334, to Latounnette, et al. (“Preparation of Zeolites 4A and/or 13X”); U.S. Pat. No. 4,649,036 to Pastorello, et al. (“Process for the Manufacture of Zeolites 4A . . . ”); U.S. Pat. No. 5,487,882 to Hu, et al. (“Process for Preparation of Zeolite ‘X’”); U.S. Pat. No. 6,258,768, to Araya (“Zeolite P . . . ”); and U.S. Pat. No. 4,264,562, to Kostinko (“Method of Producing Zeolite Y”).

Synthetic zeolites hold some key advantages over their natural analogs. The synthetics can, of course, be manufactured in a uniform, phase-pure state. It is also possible to manufacture desirable zeolite structures which do not appear in nature. Zeolite A is a well-known example. Examples of synthetic zeolites are the A, P, X and/or Y types. One example of a type A zeolite has the chemical formula Na₂O:2SiO₂: Al₂O₃:3.94H₂O, wherein the quantity of Na₂O is 17%, Al₂O₃ is 29%, SiO₂ is 34% and H₂O is 20%. U.S. Pat. No. 4,264,562, to Kostinko gives a description of different synthetic zeolite types.

The general formula for zeolites can be expressed by Na₂O:xSiO₂:Al₂O₃:yH₂O. Zeolite X will have χ=2.5±0.5, Zeolite A will have χ=1.85±0.5, Zeolite Y will have χ=4.5±1.5. U.S. Pat. No. 6,258,768 (Arraya) describes the typical formula for Zeolite P where χ will vary from 1.80 up to 2.66. The water content on the structure, represented by y is variable and can reach up to 9. Typical values for Zeolite X are 6.2 and Zeolite A is 3.91. One skilled in the art will recognize that the different water retention for the different zeolites will affect the amount of zeolite that is useful in processes according to the invention.

Zeolite may be used in asphalt production as a water release agent to induce a controlled and efficient foaming process that aids in the workability of the asphalt mix and allows effective coating of the aggregate to take place at temperatures between about 10° C. and 24° C. below hot mix asphalt (HMA) operations within the drum of a dryer drum plant or in the pugmill of a batch plant. Typical HMA operations occur at a temperature of about 152° C., while addition of zeolite allows the WMA operations to occur at about 120° C.

Hydrated lime (calcium hydroxide, having the chemical formula Ca(OH)₂, and also known as slake lime and pickling lime), creates multiple benefits when mixed with hot mix asphalt. Hydrated lime is a mineral filler that is often used in both HMA and WMA to reduce moisture damage.

Although applicants do not wish to be bound by theory, it is believed that hydrated lime may promote the development of organic salts when calcium ions from the lime couple with carboxylic acids and keep these acids from bonding to sites on the aggregate surface. When this carboxylic acid—aggregate bond forms, it is easily replaced by water, when moisture diffuses to the aggregate-asphalt interface. The result is moisture induced damage of the asphalt pavement. It is generally believed that when calcium from lime interacts with carboxylic acids and essentially “ties it up” other functionalities in the asphalt are allowed to migrate to the aggregate surface and form more stable bonds that are more resistant to replacement by water.

Lime has other very favorable effects. It acts as a filler and toughens the mastic. The toughening effect is of peak importance when moisture diffuses into the mastic. The presence of moisture in the mastic reduces the elasticity of the mastic and increases its potential for damage (by decreasing shear modulus and increasing phase angle).

The presence of lime as a filler significantly improves the mastic's ability to maintain a higher level of elasticity (higher modulus and lower phase angle), and resists accumulation of damage. Furthermore, in most asphalts, lime is considered to be an active filler rather than an inert filler as it interacts with functionalities that comprise the asphalt. This interaction “magnifies” the effect of the filler.

Warm mix usage is increasing at a remarkable rate and the supporting technologies are advancing at an equally impressive rate. The benefits of WMA over HMA are well established in terms of energy savings and reduction of harmful emissions. Furthermore, numerous field test sections and experiments have proven the efficacy of the technology, and the transition from HMA to WMA will continue to take place.

Unfortunately, research at Texas A&M University has established that even a very small amount of residual moisture on or near the aggregate surface can reduce the total energy of adhesion or bonding energy. Lower mixing temperatures such as those used in WMA production can in some cases lead to a higher risk of residual moisture on or near the aggregate surface. The addition of lime in the WMA process can substantially lessen the deleterious impact of moisture and reduce the risk of moisture-induced damage. In fact certain departments of transportation, for example the Georgia Department of Transportation in the U. S. and the Saskatchewan Department of Highways, Canada, require the use of lime in HMA and WMA.

Hydrated lime has some ability to control water sensitivity in HMA and also acts as an antistrip additive to inhibit moisture damage. Lime also generates other effects in HMA. Specifically, lime acts as an active filler, and as an additive that reacts with clay fines in HMA. These mechanisms create multiple benefits for pavements, including acting as a mineral filler; stiffening the asphalt binder; improving resistance to fracture growth (i.e., it improves fracture toughness) at low temperatures; favorably altering oxidation kinetics and interacting with products of oxidation to reduce their deleterious effects; and altering the plastic properties of clay fines to improve moisture stability and durability.

In the asphalt field, stripping is commonly defined as “loss of adhesion between the aggregate surface and asphalt cement binder in the presence of moisture.” An HMA may experience loss of strength in the presence of moisture without visible evidence of de-bonding because water may affect the cohesive strength of the asphalt binder. Thus, the terms “water susceptibility” and “water sensitivity” are often used to designate the loss of strength or other properties of HMA in the presence of moisture.

Typically the water susceptibility of HMA is controlled by a number of factors, which may include aggregate properties, asphalt cement binder properties, mixture characteristics, climate, traffic, construction practices, and pavement design considerations. The physical-chemical mechanisms responsible for stripping in asphalt-aggregate mixtures are complex and may never be fully understood. Detachment, displacement, emulsification, pore water pressure, hydraulic scouring, and asphalt-aggregate interfacial physical-chemistry have been proposed to define the cause of water susceptibility problems.

A number of additives to reduce moisture sensitivity and stripping are used in the United States. The most widely used anti strip additive is hydrated lime. Others include liquid amines and diamines, liquid polymers, Portland cement, fly ash, and flue dust. Pavement contractors sometimes prefer liquid anti strip additives as they are relatively easy to use.

To overcome being washed away, the liquid anti-stripping agents must be given time to cure (in excess of three hours). In contrast, hydrated lime cures rapidly (within 15 to 30 minutes) and forms water insoluble compounds. Hydrated lime creates a very strong bond between the bitumen and the aggregate, preventing stripping at all pH levels. Part of the reason for the bond can be due to the pozzolanic reaction between silica and alumina in the aggregate fines. Pozzolanic reactions between lime and certain fines can also add to mix stability.

Lime can be added to HMA during the production process by a number of methods. Techniques used to add lime to HMA range from adding dry lime to the drum mixer at the point of asphalt binder entry or through a pugmill to adding lime to aggregate followed by “marination” for several days to adding lime as a fine filler just before introduction of the liquid asphalt at the lower portion of the drum. Typically addition is made early in the drum at about the aggregate addition point.

Lime can be successfully proportioned and mixed in HMA in both batch and drum mixers. Dry lime can be added to dry aggregate and to wet aggregate. Moisture levels in wet aggregate are typically about two to three percent above the saturated surface dried condition of the aggregate. Moisture ionizes the lime and helps distribute it on the aggregate surface. Moisture may also activate pozzolanic reactions between the lime and certain fine materials.

Lime treated aggregates can be stockpiled for “marination” or can be conveyed directly to the drying and mixing portion of the HMA production unit. The advantages of marination include a reduction in moisture content while the aggregate is stockpiled; the ability to perform the lime treatment separately from the HMA production with some economic advantage; and a possible improvement in the resistance to moisture (particularly when aggregates have clays present in their fines or have clay coatings). The treatment of aggregates followed by marination also allows for the use of the lime on only problematic or strip-prone aggregate. For example, a fine aggregate may be highly water sensitive while coarse aggregates may not be water sensitive.

Disadvantages of marination include: additional handling of the aggregate; additional space to accommodate both lime-treated and untreated stockpiles; and lime can be washed from the aggregate during marination. Carbonation of the lime in stockpiles of aggregate does not appear to be a major problem as it usually occurs primarily near the surface of the stockpile.

Lime slurries made from hydrated lime or quicklime have also been used. Aggregates treated with lime slurry are conveyed directly to the drying and mixing portion of the HMA facility or placed into stockpiles for marination. The use of lime slurries has several potential advantages: improved resistance of the treated hot mix to stripping; reduced dusting associated with the addition of dry lime to the aggregate; and improved distribution of the lime on the aggregate. However, the use of lime slurries adds more water than is typically used for conventional lime applications and can substantially increase the water content of the aggregate prior to entering the drying and mixing portions of the HMA facility. Increased fuel consumption and reduced HMA production can result. The use of lime slurries also requires purchasing or renting specialized equipment to prepare the lime slurry at the site of the mixing operation.

It would be helpful to have a way to alter the traditional HMA production process to decrease potential stripping and to decrease the temperature that is required for the production of the asphalt.

### BRIEF SUMMARY OF THE INVENTION

Embodiments provide an asphalt filler comprised of a combination of zeolite and hydrated lime in a prescribed blend ratio. Addition of this filler (blend for a prescribed ratio of zeolite and lime) to HMA hot-mix asphalt is more beneficial than addition of either zeolite or hydrated lime alone. The beneficial properties offered by the zeolite include a controlled release of moisture during the period of plant operations when workability of the mix and the ability to effectively coat the aggregate (or blend of aggregate and recycled materials—e.g., recycled asphalt pavement or recycled asphalt shingles) with the asphalt binder or of the binder to coat the aggregate is of critical importance. This control release of moisture aids both workability and coating efficiency. Furthermore, the unique nature of zeolite does not allow release of moisture below mixing temperatures, where such moisture release would be detrimental to the mix. \

The benefits of hydrated lime in reducing moisture damage add a second eschelon of protection, which is particularly beneficial for warm mix technology where residual moisture in the aggregate is a concern. The presence of lime offers other well established benefits to the mixture including the active filler effect, which improves mastic toughness even at higher moisture contents, reduced negative effects of oxidative aging, resistance to fatigue damage, and improved adhesive and cohesive properties of the mixture in but dry states and in the presence of moisture. The mixture of zeolite and hydrated lime is easier to handle and integrate into a process than use of either compound alone.

This leads to potentially significant processing and financial advantages, as are set forth more fully below.

### DETAILED DESCRIPTION OF THE FIGURES

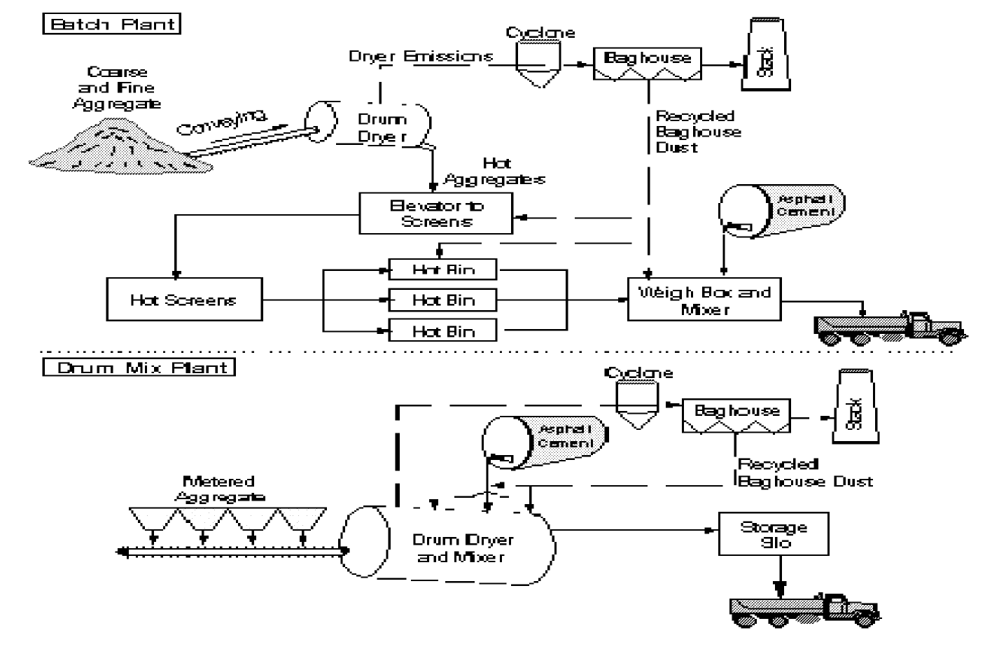

FIG. 1 shows typical batch and drum processes for asphalt mixing.

### DETAILED DESCRIPTION OF THE INVENTION

### I. Combinations of Lime and Zeolite

We have found that zeolite and hydrated lime share many similar physical properties including similar specific gravities, size distribution, and general handling properties. These similar handling properties enhance the potential for introducing hydrated lime and zeolite simultaneously in both drum and batch plant operations. These similar properties promote the potential to distribute a composite blend of zeolite and lime in the asphalt mix so that a more even distribution of both can be achieved. This uniformity of distribution enhances the mixture's benefits as a filler.

The similarities of zeolite and lime allow zeolite to serve as a partial substitute for lime as a filler. In this sense, once zeolite serves its function as an agent to produce a controlled and uniform foaming action during WMA preparation, zeolite's function is not complete; the zeolite that has released much of its moisture now serves as part of the zeolite-lime mineral filler. It is important to understand that any residual moisture retained in the zeolite structure after its release at mixing temperatures, above 100° C. (212° F.), will be “locked in” the zeolite structure and cannot be released under pavement service temperatures. Therefore, zeolite will not be a contributor of deleterious moisture to the final asphalt product.

Simultaneous introduction of zeolite and hydrated lime promote control of the distribution of hydrated lime in the asphalt mix in a manner that is unique. While hydrated lime has been introduced in drum plants as a filler, it has never been added as a composite with zeolite, which produces a controlled foaming process. In this process the release of moisture from zeolite is controlled as well as the size of the foaming bubbles and their size distribution. For example, upon heating the 4A zeolite water bubbles are emitted from the sodium aluminosilicate crystal that has a pore diameter of 4 Angstrom.

This promotes a “carrier” mechanism for the hydrated lime and the potential for a highly uniform distribution on the surface of the aggregate and within the asphalt binder. This uniformity of mixing, in turn, optimizes the potential for hydrated lime to promote a tenacious, efficiently distributed adhesive bond and to uniformly improve the cohesive strength of the mastic in both dry conditions and when moisture diffuses into the mastic.

Mixtures of hydrated lime and zeolite may take different forms. For example, in one embodiment they are presented as a powder-powder combination of zeolite and hydrated lime.

In another embodiment the hydrated lime and zeolite are presented as a spray dried granule of zeolite and hydrated lime as a single larger particle. This may be prepared as set forth below in the Examples. In other embodiments, the zeolite and lime powders are granulated on a granule that is larger than a spray-dried granule. Typically spray-dried or granulated compositions provide better handling than the powder mixture because the flow properties are greatly improved and because handling fine powders is challenging from an engineering standpoint. This improved handling is a trade-off with potential performance, however, because the powder mixture is likely to provide better performance than the granulated mixture. The spray dried or granulated form is likely to offer storage benefits. Dosing is likely to be simplified in the granulated form as well.

FIG. 1 shows both batch and drum processes for asphalt production. When added alone in a batch operation, zeolite is typically added at the “Weight Box and Mixer.” This is also the preferred point for addition of the mixture of zeolite and hydrated lime. In a drum plant the zeolite alone is typically added in the “Drum Dryer and Mixer,” but as close as possible (if not together) with the addition of asphalt cement. The combination of zeolite and hydrated lime is preferably added as close as possible to the liquid asphalt cement in the drum plant.

Typically, the zeolite/lime would be air conveyed or screw conveyed from a storage hopper/bin to a location in the drum where the bitumen/AC is feed into the drum. There generally is a distribution device in the drum, known as a dog box, where the bitumen is fed. It distributes in this device and cascades over a slight dam onto the hot aggregate. The zeolite/lime mixture would be conveyed into this dog box or directed at the bitumen stream from a distribution header in the drum. In a batch plant, the zeolite/lime mixture would transported by air dense phase equipment, screw conveyed, or dropped from a gravity hopper above the pug mill, into the pug mill once the bitumen starts to feed into the pug mill. The goal is to distribute the zeolite/lime mixture into the bitumen to distribute over the hot aggregate as opposed to directly onto the hot aggregate where the functionality of the zeolite would be negatively affected.

Those skilled in the art will recognize that additional additives may be included in the production of the asphalt. For example, other anti-stripping agents may be included, such as polyamine and amidoamine derivatives. Polymers such as polyethylene, polypropylene, polyolefins, styrene butadiene (block copolymers or rubber latex), rubber latex, and crumb rubber may be included. Extenders may be added, such as, for example, phosphoric acid modifiers, extender oils, sulfur, and Gilsonites.

In further embodiments of the invention, the zeolite/lime mixture is also mixed with an effective amount of recycled asphalt pavement or recycled asphalt shingles. The addition of zeolite alone or zeolite with lime may increase the amount of RAS or RAP that is tolerated by the asphalt mixture due to the impact of zeolite on the composite viscosity of the blend.

The examples below help illustrate a number of possible embodiments of the invention. Of course, the embodiments of the invention are not limited to the examples shown.

### II. EXAMPLES

### Example 1

### Preparation of a Mixture of Hydrated Lime and Zeolite

In embodiments of the invention the ratio of lime to zeolite is 4 parts of lime to 1 part of zeolite. Typically lime is used in a range of 0.5 to 2.5 wt % of the asphalt mix, preferably 1% to 2% by weight. Zeolite is present in a range between 0.1 to 0.35 wt % of the mix, typically 0.2 to 0.25 wt %.

In a dry mix, zeolite and hydrated lime powders are mixed in typical powder-powder devices. One example could be a paddle or ribbon mixer where the two powders are added in the right proportion and are thoroughly mixed by rotating paddles inside a chamber. The outlet of the chamber can be directed to a packing station into bulk bags or bulk trucks.

Example 1 describes creation of a granulated mixture of zeolite and hydrated lime. Zeolite and hydrated lime are mixed and dispersed in a slurry form with the addition of water and, if necessary a binder. Sodium Silicate is a possible binder. Other possible binders include potassium silicate, molasses, calcium silicate, calcium limestone, dolomitic limestone, and bentonite clays. The slurry is pumped to the spray drier into the feed where it is atomized into small droplets in the hot air chamber. The hot air will dry the residual water in the droplet resulting on a granule of about 50-150 microns in size, composed of the zeolite and hydrate lime. Zeolite will preserve the water in the crystalline structure, as the drying process will not have sufficient heat to drive them out of the structure.

Following completion of drying, the particles of product must be separated from the drying air. Primary separation is accomplished by the particles simply falling to the bottom of the chamber. A small fraction of the particles remain entrained with the air and must be recovered in separation equipment. Cyclones, bag filters, and electrostatic precipitators may be used for the separation. Typically in both the granulated mixture and the non-granulated mixture, four parts of lime to one part of zeolite are used. Typically the amounts are chosen to allow addition of hydrated lime at 1% of asphalt mix and zeolite at 0.25% of asphalt mix, both by weight.

### Example 2

### Preparation of Asphalt using a Mixture of Hydrated Lime and Zeolite

Asphalt is prepared by heating aggregates to eliminate residual moisture. The aggregates have a specific gradation according prescribed by the mix design and this can vary in terms of aggregate size and percent within each size range. Normally 3 or 4 different types of aggregates are blended to form a specific mix design.

The addition of zeolite allows the asphalt production plant to reduce its operating temperature from an average of 150° C. to 120° C. because of the effect of the release of micro water steam bubbles from the zeolite structure when heated at this temperature. Upon heating above 100° C., water will be emitted from the zeolite structure causing micro-foaming in the asphalt concrete.

The point of addition of the hydrated lime/zeolite mixture should be as close as possible to the addition of bitumen so the water release from its structure will effectively act to cause micro-foaming of the bitumen. Preferably the zeolite will be in contact with the oil prior to hitting the aggregate. If zeolite is added at the beginning of the aggregate heating process, the water will be released before it gets into contact with bitumen. If the water is released from the zeolite structure before the zeolite encounters the liquid asphalt the micro foaming effect does not develop and zeolite becomes a simple filler within the mix. With no micro foaming effect the operation at lower temperatures would become impossible in the asphalt plant, resulting on a unworkable mix.

Patents, patent applications, publications, scientific articles, books, web sites, and other documents and materials referenced or mentioned herein are indicative of the levels of skill required for this invention. Inclusion of a document in this specification is not an admission that the document represents prior invention or is prior art for any purpose.

We claim:

1. A filler for asphalt, comprising:
lime; and
zeolite.

2. The filler of claim 1, wherein the zeolite and lime are present in a ratio, by weight, of 2 to 6 parts lime to 1 part zeolite.

3. The filler of claim 1, wherein the zeolite and lime are present in a ratio, by weight, of 3 to 5 parts lime to 1 part zeolite.

4. The filler of claim 1, wherein the zeolite and lime are present in a ratio, by weight, of 4 parts lime to 1 part zeolite.

5. The filler of claim 1, further comprising water.

6. The filler of claim 5, wherein at least some of said water is adsorbed by the zeolite.

7. The filler of claim 1, further comprising a binder.

8. The filler of claim 7, wherein said binder is selected from the group consisting of sodium silicate, potassium silicate, molasses, calcium silicate, calcium limestone, dolomitic limestone, and bentonite clay.

9. The filler of claim 8, wherein the binder is sodium silicate.

10. The filler of claim 7, wherein said binder is present in an amount between 0.2 to 2% by weight.

11. The filler of claim 1, wherein the filler is a powdered filler.

12. The filler of claim 1, wherein the filler is a granulated filler.

13. An asphalt mix comprising:
asphalt;
lime in an amount of 0.5 to 2.5 percent of the asphalt mix, by weight; and
zeolite in an amount of 0.1 to 0.35 percent by weight of the asphalt mix.

14. A process for preparing an asphalt filler comprising a granulated mixture of zeolite and lime, comprising:
mixing zeolite, lime, water, and a binder;
dispersing the mixture of zeolite, lime, water, and a binder to form a slurry;
atomizing the slurry;
drying the atomized slurry to form an asphalt filler comprising a granulated mixture comprising zeolite, lime, water, and a binder.

15. The process of claim 14, wherein, the zeolite and lime are mixed in a ratio, by weight, of 2 to 6 parts lime to 1 part zeolite.

16. The filler of claim 1, wherein the zeolite and lime are mixed in a ratio, by weight, of 3 to 5 parts lime to 1 part zeolite.

17. The filler of claim 1, wherein the zeolite and lime are mixed in a ratio, by weight, of 4 parts lime to 1 part zeolite.

18. A method for preparing warm mix asphalt, comprising:
drying a mix of aggregates to eliminate free water in the mix;
adding recycled asphalt materials to the mix;
adding a filler comprising zeolite and lime;
adding the liquid asphalt cement; and
mixing to prepare a warm mix asphalt.

19. The method of claim 18, wherein said recycled asphalt materials are selected from the group consisting of recycled asphalt shingles and reclaimed asphalt pavement.

20. The method of claim 18, wherein said warm mix asphalt comprises lime in an amount of 0.5 to 2.5 percent of the asphalt mix, by weight; and
zeolite in an amount of 0.1 to 0.35 percent by weight.
